(19) United States
(12) Patent Application Publication
(10) Pub. No.: US 2011/0180293 A1
(43) Pub. Date: Jul. 28, 2011

(54) SHIELDING CONDUCTOR CONNECTING STRUCTURE OF TERMINAL FOR SUPER-CONDUCTOR CABLE

(75) Inventors: Hyun Man JANG, Hwaseong-si (KR); Su Kil LEE, Gumi-si (KR); Choon Dong KIM, Gunpo-si (KR); Chang Youl CHOI, Gumi-si (KR); Heo Gyung SUNG, Busan (KR)

(73) Assignee: LS CABLE LTD., Anyang-si (KR)

(21) Appl. No.: 13/005,607

(22) Filed: Jan. 13, 2011

(30) Foreign Application Priority Data
Jan. 22, 2010 (KR) 10-2010-0005862

(51) Int. Cl. H02G 15/34

(52) U.S. Cl. 174/15.5

(57) ABSTRACT

Disclosed herein is a shielding conductor connecting structure of a terminal for super-conductor cable. The shielding conductor connecting structure includes an inner cryostat for forming an extremely low temperature portion while having a super-conductor cable formed therein, an outer cryostat formed with an interval so that a shielding conductor is extracted from the super-conductor cable, a plurality of vacuum tubes formed at an interval to protrude along an outer circumferential surface of the outer cryostat, a short-circuit conductor formed in each of the vacuum tubes to be connected to another phase connection portion and a short-circuit conductor connection portion formed in the interior of the outer cryostat and connected to the short-circuit conductor in the vacuum tube while being connected to the shielding conductor connected to the super-conductor cable.

### CROSS-REFERENCE TO RELATED APPLICATION

This application claims priority to Korean Patent Application No. 10-2010-0005862, filed on Jan. 22, 2010, and all the benefits accruing therefrom under 35 U.S.C. §119, the contents of which in its entirety are herein incorporated by reference.

### BACKGROUND

1. Field of the Invention

Disclosed herein is a shielding conductor connecting structure of a terminal for super-conductor cable. More particularly, disclosed herein is a shielding conductor connecting structure of a terminal for super-conductor cable, which can reduce heat loss due to external heat invasion or internal heat generation.

2. Description of the Related Art

In general, a super-conductor cable terminal is a device used to connect a super-conductor cable and a normal-conductor cable to each other at an end of the super-conductor cable. FIG. 1 illustrates the configuration of a related art terminal for super-conductor cable.

As shown in FIG. 1, a terminal structure constituting the terminal for super-conductor cable includes a high temperature portion having an insulator protruded to the exterior to the terminal structure while being connected to a right end of a super-conductor cable 10, a current lead portion through which electrical current is applied to the high temperature portion, and the like. Hereinafter, the illustration and description of such a configuration will be omitted, and a portion provided at one side of the terminal to be connected to another phase terminal at the exterior thereof will be described.

As shown in FIG. 1, a shielding conductor connecting structure of the terminal for super-conductor cable includes an inner cryostat 20 cooled by liquid nitrogen to form an extremely low portion while having the super-conductor cable 10 in the interior thereof; an outer cryostat 30 formed with an interval so that a shielding conductor 12 is extracted from the super-conductor cable 10 through an extracting portion 11; a plurality of extracting ports 31 formed to protrude from the circumference of the outer cryostat 30 while passing the shielding conductor 12 therethrough; and a short-circuit conductor 33 connected to the terminal through a connection portion of the extracting port 31 so as to be connected to the other phase terminal.

The space between the inner cryostat 20 and the outer cryostat 30 is formed in a vacuum state to prevent heat invasion.

Here, loss caused by shielding current can be prevent only when the short-circuit conductor 33 is short-circuited from another phase terminal so as to be grounded. However, in the related art terminal, the short-circuit conductor 33 connected to the other terminal is configured to be extracted to the exterior, and therefore, heat invasion from the exterior to the terminal for super-conductor cable may occur.

In order to minimize the heat invasion, it is possible to reduce the size of the short-circuit conductor 33. However, as the area of the short-circuit area is decreased, its resistance is increased. Therefore, heat generated by shielding current is increased, and loss caused by the shielding current is also increased.

That is, as the sectional area of the short-circuit conductor is increased, the amount of heat generation is decreased, but the amount of heat invasion is increased in proportion to the sectional area. Therefore, it is unavoidable that heat loss occurs.

### SUMMARY OF THE INVENTION

Disclosed herein is a shielding conductor connecting structure of a terminal for super-conductor cable, which uses a super-conductor line material, thereby preventing heat from being generated by shielding current and reducing heat loss caused by heat invasion.

In an aspect, there is provided a shielding conductor connecting structure of a terminal for super-conductor cable, which includes an inner cryostat for forming an extremely low temperature portion while having a super-conductor cable formed therein; an outer cryostat formed with an interval so that a shielding conductor is extracted from the super-conductor cable; a plurality of vacuum tubes formed at an interval to protrude along an outer circumferential surface of the outer cryostat; a short-circuit conductor formed in each of the vacuum tubes to be connected to another phase connection portion; and a short-circuit conductor connection portion formed in the interior of the outer cryostat and connected to the short-circuit conductor in the vacuum tube while being connected to the shielding conductor connected to the super-conductor cable.

A wrinkled expansion and contraction portion may be formed to be flexible at the vacuum tube so that the length of the vacuum tube is expanded and contracted and so that the direction of the vacuum tube is changed freely.

The short-circuit conductor formed in the vacuum tube may be formed by connecting and fixing a super-conductor line material to the circumference of a copper conductor so as to prevent heat from being generated by shielding current.

The short-circuit conductor connection portion may be formed of a copper conductor or formed by connecting and fixing a super-conductor line material to the circumference of the copper conductor.

The shielding conductor may be formed of a flexible braided wire to allow thermal expansion and contraction of the super-conductor cable.

A portion of the short-circuit conductor corresponding to the position of the expansion and contraction portion of the vacuum tube may be formed of a braided wire to be flexible.

The short-circuit conductor formed of the copper conductor and the super-conductor material line connected and fixed to the circumference of the copper conductor in the vacuum tube may be cooled through a conduction cooling method using a copper conductor of the short-circuit conductor connection portion from the inner cryostat that is an extremely low temperature portion.

### BRIEF DESCRIPTION OF THE DRAWINGS

The above and other aspects, features and advantages of the present invention will become apparent from the following description of preferred embodiments given in conjunction with the accompanying drawings, in which:

FIG. 1 is a schematic sectional view showing a shielding conductor connecting structure of a related art terminal for super-conductor cable; and

FIG. 2 is a schematic sectional view a shielding conductor connecting structure of a terminal for super-conductor cable according to an embodiment.

### DETAILED DESCRIPTION OF THE INVENTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

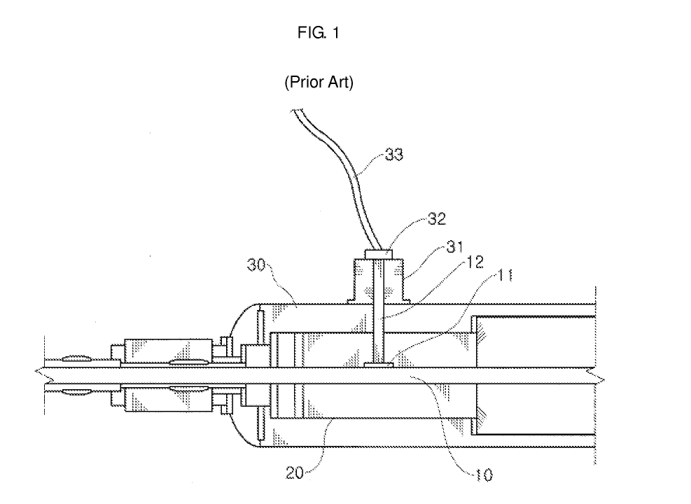

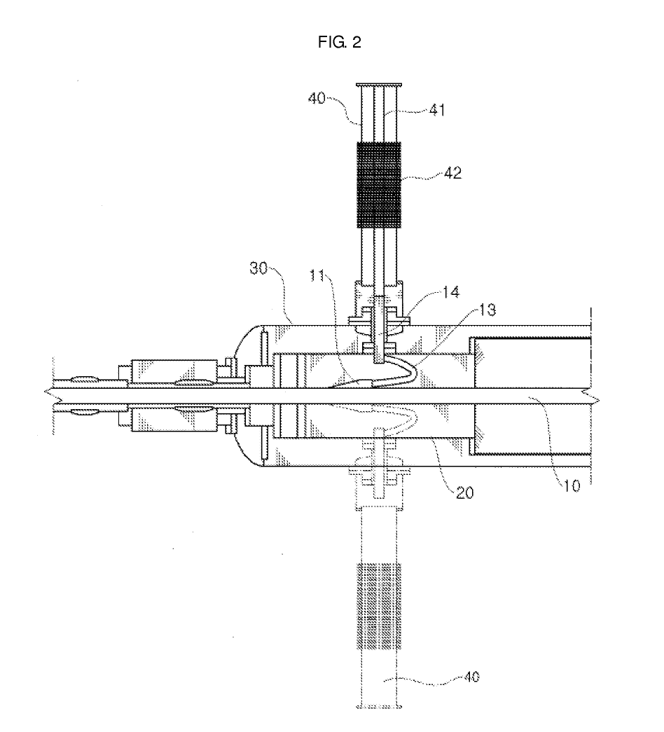

In FIG. 2, components identical to those of the related art will be described by designating them by the same reference numerals with reference to FIG. 1, and new components will be described in detail by designating them by new reference numerals.

According to an embodiment, as shown in FIG. 2, a shielding conductor connecting structure of a terminal for super-conductor cable includes an inner cryostat 20 having a super-conductor cable 10 in the interior thereof, and an outer cryostat 30 formed with an interval so that a shielding conductor 13 is extracted from the super-conductor cable 10 through an extracting portion 11.

According to this embodiment, vacuum tubes have three phases, and a plurality of vacuum tubes 40 are formed to protrude at an interval along the outer circumference of the outer cryostat 30. A short-circuit conductor 41 connected to another phase connection portion (a short-circuit conductor formed in a vacuum tube of another terminal) is formed in each of the plurality of vacuum tube 40. That is, a short-circuit connection portion 14 is formed in an interior of the outer cryostat 30 and connected to the short-circuit conductor 41 in each of the plurality of vacuum tube 40 while being connected to the shielding conductor 13 connected to the super-conductor cable 10.

When the super-conductor cable is a three phase cable, three terminals are connected to one another through vacuum tubes. At this time, two vacuum tubes are connected to one terminal. The vacuum tube is connected to that of another terminal so that two vacuum tubes are connected as one vacuum tube. Thus, the vacuum tubes of the three terminals constitute three vacuum tubes.

That is, when it is assumed that the three terminals are referred to as first, second and third terminals and that vacuum tubes corresponding to the respective terminals are sequentially referred to as vacuum tubes A, B, C, D, E and F, the vacuum tube A of the first terminal is connected to the vacuum tube F of the third terminal so as to become one vacuum tube. The vacuum tube B of the first terminal is connected to the vacuum tube C of the second terminal so as to become one vacuum tube, and the vacuum tube D of the second terminal is connected to the vacuum tube E of the third terminal so as to become one vacuum tube.

The shielding conductor 13 is formed of a braided wire with a flexible structure so as to allow for thermal expansion and contraction.

Furthermore, a wrinkled expansion and contraction portion 42 is formed to be flexible at the vacuum tube 40, so that the length of the vacuum tube 40 can be expanded and contracted and the direction of the vacuum tube 40 can be changed freely. Accordingly, stress can be reduced.

Unlike the related art short-circuit conductor, the short-circuit conductor 41 formed in the vacuum tube 40 is formed by connecting and fixing a super-conductor line material to the circumference of a copper conductor. The short-circuit conductor 41 prevents heat from being generated by shielding current.

More specifically, when the short-circuit conductor 41 is formed of only the super-conductor line material, an extremely low temperature state is necessarily maintained so that the short-circuit conductor 41 has a super-conductor property. However, liquid nitrogen cannot be flowed into the vacuum tube 40, and hence, the extremely low temperature state is not maintained. Therefore, in this embodiment, the short-circuit conductor 41 is basically formed of a copper conductor, and the super-conductor line material is connected and fixed to the circumference of the copper conductor.

The short-circuit conductor connection portion 14 is formed of a copper conductor or formed by connecting and fixing a super-conductor line material to the circumference of the copper conductor.

The short-circuit conductor 41 and the short-circuit conductor connection portion 14 are integrally connected to each other (e.g., by welding). The short-circuit conductor 14 is formed of a braided wire to be flexible at the position of the expansion and contraction portion 42 of the vacuum tube 40.

The short-circuit conductor connection portion 14 is formed of a copper conductor or formed by connecting and fixing a super-conductor line material to the circumference of the copper conductor, and the short-circuit conductor 41 in the vacuum tube 40 is formed by connecting and fixing a super-conductor line material to the circumference of the copper conductor. Thus, the short-circuit conductor 41 formed in the vacuum tube 40 can be effectively cooled through a conduction cooling method using a copper conductor from the inner cryostat that is an extremely low temperature portion.

According to this embodiment, the short-circuit conductor 41 formed in the vacuum tube 40 is formed of a copper conductor, and the super-conductor line material is connected and fixed to the circumference of the copper conductor. Thus, the heat generation can be maximally prevented as compared with the related art short-circuit conductor formed of only the copper conductor. Furthermore, the connection with another phase connection portion is performed in the interior of the vacuum tube 40, and thus, heat invasion from the exterior can be fundamentally prevented.

The short-circuit conductor 41 is the short-circuit conductor connection portion 14 formed in the interior of the outer cryostat 30 that forms an extremely low temperature portion. The short-circuit conductor connection portion 14 is basically formed of a copper conductor or formed by connecting and fixing a super-conductor line material to the circumference of the copper conductor, and hence, the short-circuit conductor 41 connected to the short-circuit conductor connection portion 14 (in an integrated state) is effectively cooled by the conductor phenomenon. Thus, the short-circuit conductor 41 can be cooled below the critical temperature of the super-conductor line material.

According to this embodiment, the wrinkled expansion and contraction portion 42 is formed at the vacuum tube 40 so that the expansion and contraction of the vacuum tube 40 is free. Accordingly, the vacuum tube 40 can be well bent. The plurality of vacuum tubes 40 are formed along the circumferential surface of the outer cryostat 30 (in this embodiment, two vacuum tubes are formed at one terminal). Therefore, although a deviation occurs in the contraction of the vacuum tube 40, it is properly adjusted. Accordingly, the connection state of the vacuum tube 40 can be well maintained.

When the short-circuit conductors 41 in the vacuum tubes 40 formed at each of the terminals are connected to each other so as to connect to the terminals to one another, the portion of the short-circuit conductor 41, positioned at the expansion and contraction portion 42 of the vacuum tube 40, is formed of a braided wire to be flexible, and therefore, the short-circuit conductors 41 are easily connected to each other. Accordingly, the phase connection portions can be simply connected to one another.

In a shielding conductor connecting structure of a terminal for super-conductor cable, disclosed herein, a short-circuit conductor is connected in a vacuum state without being exposed to the exterior through a vacuum tube so as to prevent shielding current of each of the phase connection portions by connecting shielding conductors to each other. Accordingly, heat loss caused by heat invasion can be reduced.

Also, the short-circuit conductor is formed by connecting and fixing a super-conductor line material to the circumference of a copper conductor, so that it is possible to prevent loss of heat generated by shielding current.

Also, the short-circuit conductor in the vacuum tube can be effectively cooled through a conduction cooling method using a copper conductor.

Also, when short-circuit conductors in vacuum tubes of each terminal are connected to each other, a flexible expansion and contraction portion is formed at the vacuum tube, and a portion of the short-circuit conductor that is a position corresponding to the expansion and contraction portion is formed of a braided wire to be flexible. Accordingly, phase connection can be easily and simply performed while allowing thermal expansion and contraction.

Also, the shielding conductor is formed to be flexible, so that a change caused by thermal expansion and contraction of a super-conductor cable can be effectively adjusted.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A shielding conductor connecting structure of a terminal for super-conductor cable, comprising:
an inner cryostat for forming an extremely low temperature portion while having a super-conductor cable formed therein;
an outer cryostat formed with an interval so that a shielding conductor is extracted from the super-conductor cable;
a plurality of vacuum tubes formed at an interval to protrude along an outer circumferential surface of the outer cryostat;
a short-circuit conductor formed in each of the vacuum tubes to be connected to another phase connection portion; and
a short-circuit conductor connection portion formed in the interior of the outer cryostat and connected to the short-circuit conductor in the vacuum tube while being connected to the shielding conductor connected to the super-conductor cable.

2. The shielding conductor connecting structure according to claim 1, wherein a wrinkled expansion and contraction portion is formed to be flexible at the vacuum tube so that the length of the vacuum tube is expanded and contracted and so that the direction of the vacuum tube is changed freely.

3. The shielding conductor connecting structure according to claim 1, wherein the short-circuit conductor formed in the vacuum tube is formed by connecting and fixing a super-conductor line material to the circumference of a copper conductor so as to prevent heat from being generated by shielding current.

4. The shielding conductor connecting structure according to claim 1, wherein the short-circuit connection portion is formed of a copper conductor or formed by connecting and fixing a super-conductor line material to the circumference of the copper conductor.

5. The shielding conductor connecting structure according to claim 1, wherein the shielding conductor is formed of a flexible braided wire to allow thermal expansion and contraction of the super-conductor cable.

6. The shielding conductor connecting structure according to claim 2, wherein a portion of the short-circuit conductor corresponding to the position of the expansion and contraction portion of the vacuum tube is formed of a braided wire to be flexible.

7. The shielding conductor connecting structure according to claim 3, wherein the short-circuit conductor formed of the copper conductor and the super-conductor material line connected and fixed to the circumference of the copper conductor in the vacuum tube is cooled through a conduction cooling method using a copper conductor of the short-circuit conductor connection portion from the inner cryostat that is an extremely low temperature portion.
